(19) United States
(12) Patent Application Publication
(10) Pub. No.: US 2001/0027411 A1
(43) Pub. Date: Oct. 4, 2001

(54) Method of maintaining and selling software

(75) Inventor: Kenjiroh Ikeda, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/826,243

(22) Filed: Apr. 4, 2001

(30) Foreign Application Priority Data
Apr. 4, 2000 (JP) 106719/2000

(51) Int. Cl. G06F 17/60

(52) U.S. Cl. 705/10

(57) ABSTRACT

A method of maintaining and selling software capable of maintaining the software without depending upon a designer of a software component when improvements in the software is required. In the method, improved sources are widely invited from a user, by laying open on a network a sales information such as a specification of the component and an agreement information such as conditions of an agreement or the like. Appropriately improved source is then selected from among applied improved sources and is incorporated in the software to be executed.

### BACKGROUND OF THE INVENTION

The present invention relates to a method of maintaining and selling software for performing maintenance of the software without depending upon the designer of a software component.

Conventionally, improvements in the software and version-upgrade thereof sold under a license have been performed by the designer of the software component. A typical example of a conventional method of maintaining the software will be described below with reference to a flow chart as shown in FIG. 2.

While a license to use the software is on sale (step S202), and if an improvement in the software is required (step S203), it is then determined whether or not the designer of a software component (a person who has developed it or a person who is in charge of its version-upgrade) can improve the software used at the time when there is the requirement (step S204). If the designer can improve the software (YES in step S204), he or she performs improvements in the software based on a maintenance agreement (step S205). After completion of the improvement, the software with a new version that incorporates the improvement (step S206) is made and a license to use the software is continued to be sold in step S202.

If the designer cannot improve the software (NO in step S204), it is determined in step S207 whether or not a source of the software component is held. If the source is held (YES in step S207), search is made in step S208 for a personnel who performs the improvement. If the personnel is found (YES in step S209), he or she performs the improvement after entering into an agreement for the improvement operation (step S205). Upon completion of the improvement, the software with a new version which is incorporating the improved part is made in step S206. Therefore, sale of a usage license of the software is continued in step S202.

If any personnel who performs the improvement is not found (NO in step S209), or if the source of the software component is not held (NO in step S207), an alternative component is searched which is similar in specification to the software component currently used (step S210).

If the alternative component is found (YES in step S211), the software with a new version is made in step S212 by replacing the component, thus continuing sale of a usage license of the software (step S202). However, if an alternative component is not found (NO in step S211), sale of a usage license of the software is suspended or sale is continued as is (step S213).

However, the conventional method of maintaining software has the following problems. Firstly, maintenance operation for the software associated with sale of a usage license depends heavily on whether or not the designer who has designed a software component of current version used in the software (a person who has developed it or a person who is in charge of its version-upgrade) can perform an improvement operation. That is, a person who has designed the software component does not always work in a company that is selling the software, when there is a request for improvements in the software. This comes from an employment system adopted in the software industry that is employing temporary employees or contract employees, and from that system which is highly mobile.

Secondly, in view of the first problem, the designer who has been engaged in development of a software component should in many cases enter into an agreement for the maintenance. The designer is therefore obliged to do a long-range maintenance, and the designer cannot always make a properly improved source if time has passed since he or she has designed the software.

A third problem is that, if the designer who has designed a software component makes an improved source, the source becomes simple or uniform. Such a source has no object to be compared with, thus it is difficult to evaluate the improved source.

Fourthly, since the designer of a software component enters in many cases into an agreement concerning improvements before starting an improvement operation, it is difficult for the designer to judge the validity of remuneration for the improvement. In other words, if remuneration is fixed by an agreement before surveying sale of the software, the designer may not be able to obtain a reasonable payment for making an improved source of the software even when the software makes a hit.

### SUMMARY OF THE INVENTION

The present invention has been made in view of the foregoing problems, and it is an object of the present invention to provide a method of maintaining and selling software, comprising the steps of practicing a first sale of the software; determining whether or not improvements in the software that is on sale are required; inviting when the improvements are required, an improved source by making public via a network a sales information and an agreement information associated with the software; performing examination on the improved source applied in response to the invitation in the inviting step; and carrying out a version-upgrade to incorporate in the software the improved source that has been determined to be accepted, as a result of the examination performed in the performing step.

In order to attain such an object, a method of maintaining and selling software according to a first aspect of the present invention includes as the sales information, a specification of a software component, a source program of the software, and sales figures regarding the software already sold.

A method of maintaining and selling software according to a second aspect of the present invention further comprises a step of judging whether the invitation is continued or not, if the result of the examination indicates that there is no appropriately improved source, wherein if it is judged in the judging step that the invitation is continued, conditions of an agreement associated with the published agreement information are modified and additional improved sources are invited.

A method of maintaining and selling software according to a third aspect of the present invention, the modification of conditions is an upward adjustment to remuneration for making the improved source.

In a method of maintaining and selling software according to a fourth aspect of the present invention, if it is judged in the judging step that the invitation is not continued, sales of the software are suspended.

A method of maintaining and selling software according to a fifth aspect of the present invention further comprises a step of practicing a second sale of the software to which the version-upgrade has been carried out.

In a method of maintaining and selling software according to a sixth aspect of the present invention, a license for executing the programs stored in a server is sold by using a network in the first and second sales.

In a method of maintaining and selling software according to a seventh aspect of the present invention, the software is distributed by using a network in the first and second sales. In a method of maintaining and selling software according to an eighth aspect of the present invention, patches associated with the software are distributed by using a network in the second sale. Furthermore, in a method of maintaining and selling software according to a ninth aspect of the present invention, the network is the Internet.

### BRIEF DESCRIPTION OF THE DRAWINGS

FIG. 1 is a flow chart for describing a method of maintaining and selling the software according to an embodiment of the present invention; and

FIG. 2 is a flow chart for describing a prior art method of maintaining the software.

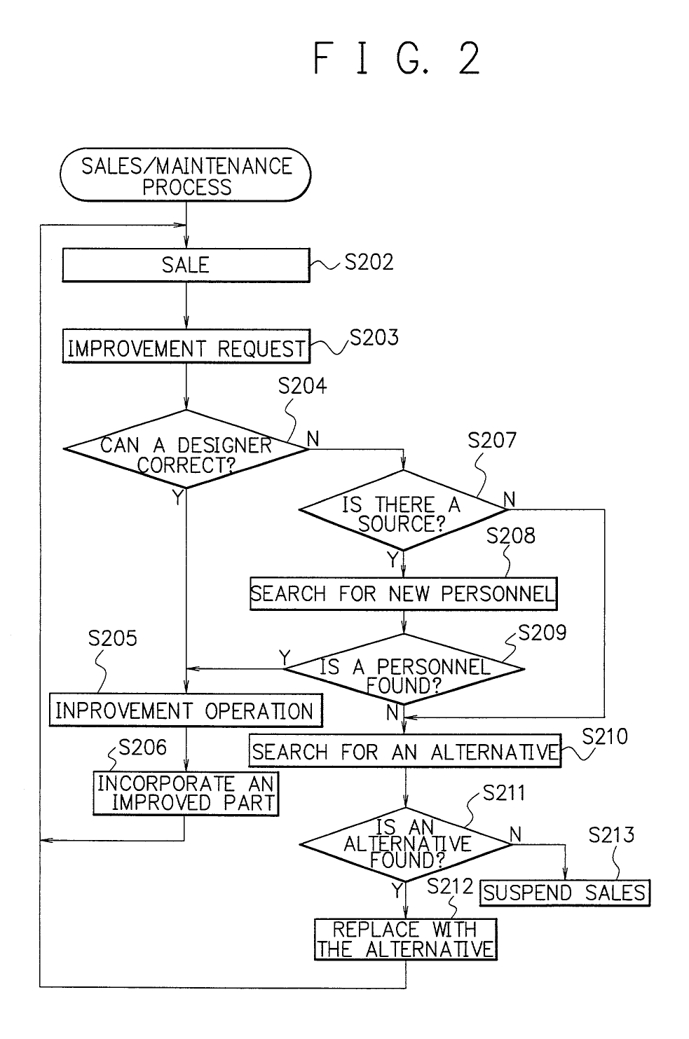

### DESCRIPTION OF THE PREFERRED EMBODIMENTS

An embodiment of the present invention will be described in detail with reference to the accompanying drawing.

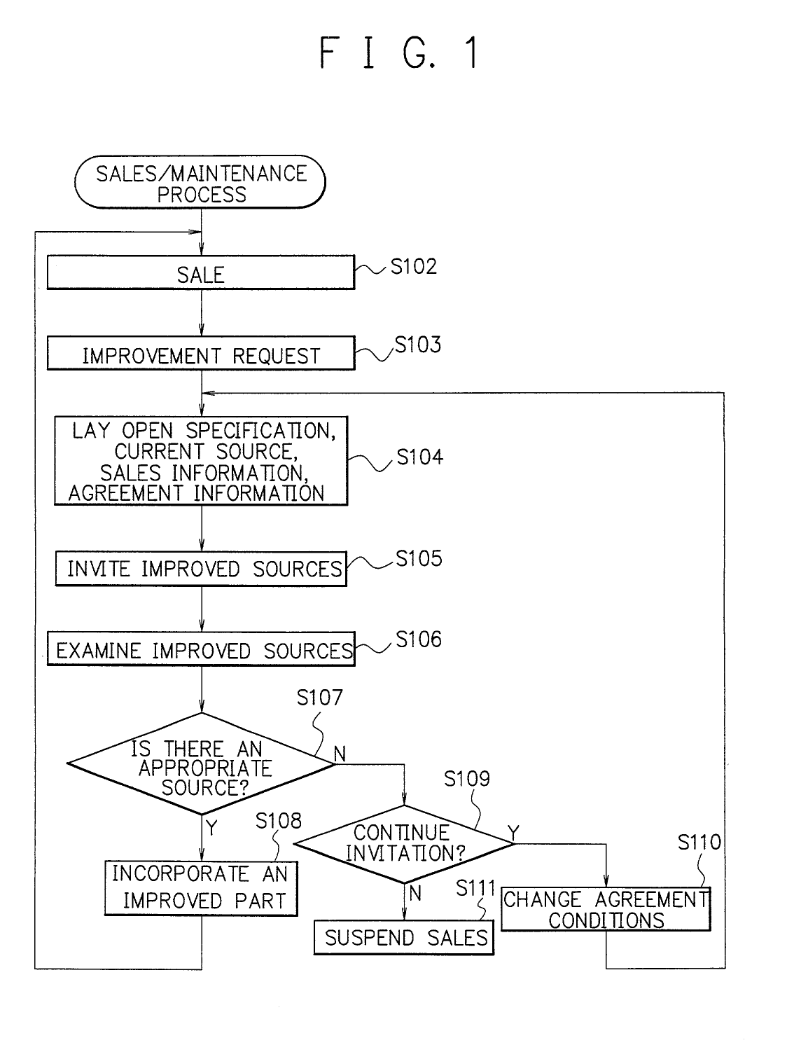

A method of maintaining and selling software according to the embodiment of the present invention will be described based on a flow chart of FIG. 1. If, while a license to use the software is on sale (step S102), improvements or changes in the software are required in step S103, the following information is made public on a network (step S104), such as a specification of a software component used at that moment, a source at that moment, a sales information on the number of sales associated with usage licenses or the like, and an agreement information about a charge for usage of the component or the like. In the next process, in step S105, improved sources are invited on the network. The network includes the Internet and a personal computer communication. Distributor of the software, a maintenance contractor entrusted by the distributor, and the like act as those who invite the improved sources.

Those who invite examine in step S106 the improved sources applied to the invitation, including examination by running a test or the like on the source. As a result of the examination, if it is determined in step S107 that there is an appropriately improved source, those who invite enter into an agreement with the designer who has made the improved source and then incorporates an improved part (step S108).

If many users apply for invitation of improved sources, those who invite can select a most excellent source. In this respect, comparing with a conventional improved source made by the designer, a user who actually uses the software often makes the right improvements by grasping the improvement points. The improved source therefore becomes a source with a higher quality because of law of competition. In addition, for a user, improvements in the software individually performed by the user can be conductive to a business. The user can also have a sense of satisfaction, because the improved source is widely used by other users.

After a process in step S108 is performed, the distributor continues sale of a usage license of the software with a new version which incorporates the improved part (step S102). More specifically, the distributor sells via the network a license for executing the programs stored in a server (not shown), as one including the improved part. With respect to a sales method, over-the-counter sales and distribution via a network can also be utilized. In the case of minor version-upgrades, correction by patching may be acceptable. According to this method, only a changed part of the software after conducting version-upgrade is distributed, the volume of data associated with communications can be brought under control. This leads to a shortening of time required for a user to download data.

If it is determined in step S107 that there is no appropriately improved source, determination is made in step S109 whether or not invitation is continued. This is made by considering all the various factors such as the size of the bugs in the software that is intended to improve by user's request, and possibility of making an appropriately improved source as far as user's level of skill is concerned. If it is necessary to continue the invitation (YES in step S109), an agreement information about, for example, charge for usage of a component is changed in step S110. Then various kinds of information are laid open again on the network in step S104 for continuing invitation in step S105. That is, remuneration for improving a source is adjusted upward for the reason of giving an incentive to apply for invitation of improved sources and collecting additional improved sources.

If the invitation is not continued (NO in step S109), sale of a usage license is suspended or sale is continued as is (step S111). If the bugs are large in size and it is difficult to make an improved source, sale is suspended. On the other hand, if the bugs are small in size or simply related to operational inconvenience, sale is continued as is.

It should be noted that a hardware configuration is well-known, which is comprising a data communication apparatus on the Internet, a personal computer, a display unit, and the like used in laying open a sales information and an agreement information, and in inviting improved sources in the steps S104 and S105, therefore illustration and description of the hardware are omitted here.

Further, the above-mentioned embodiment is an example of a preferred embodiment of the present invention, and the present invention is not limited to this embodiment but can be embodied in various forms within the scope not departing from the spirit of the present invention.

As apparent from the aforementioned descriptions, a method of maintaining and selling software according to the present invention is capable of inviting a personnel who will be in charge of the improvement other than those who have designed the software of current version (a person who has developed it or a person who handles version-upgrade). This is because a specification of a software component that requires improvements and a source of current version are laid open.

It is also possible for the designer of a software component not to be obliged to do a long-range maintenance, because a maintenance operation of the software can be performed by inviting improvement sources from a user as mentioned above, without entering into an agreement for the maintenance with a certain component designer.

Furthermore, it is possible to select by examination a most excellently improved source from among a plurality of improved sources applied by a user. This enables to obtain an improved source with a high quality. In addition, since a user actually uses the software more frequently than the designer does, the user in many cases precisely grasps the right improvements. Therefore those who invite can obtain improved sources that support the needs of other users.

It is also possible for those who are improving a software component to easily judge the validity of remuneration for the improvement, because sales information such as the number of sales of a usage license and an agreement information such as a charge for usage of the software component are made available to the user on the network.

What is claimed is:

1. A method of maintaining and selling software, comprising the steps of:
practicing a first sale of the software;
determining whether or not improvements in said software that is on sale are required;
inviting when said improvements are required, an improved source by making public via a network a sales information and an agreement information associated with said software;
performing examination on the improved source applied in response to said invitation in said inviting step; and
carrying out a version-upgrade to incorporate in said software the improved source that has been determined to be accepted, as a result of said examination performed in said performing step.

2. A method of maintaining and selling software according to claim 1, wherein said sales information includes a specification of a software component, a source program of said software, and sales figures regarding said software already sold.

3. A method of maintaining and selling software according to claim 2, further comprising a step of judging whether said invitation is continued or not, if the result of said examination indicates that there is no appropriately improved source,
wherein if it is judged in said judging step that said invitation is continued, conditions of an agreement associated with said published agreement information are modified and additional improved sources are invited.

4. A method of maintaining and selling software according claim 3, wherein said modification of conditions is an upward adjustment to remuneration for making said improved source.

5. A method of maintaining and selling software according to claim 3, wherein if it is judged in said judging step that said invitation is not continued, sales of said software are suspended.

6. A method of maintaining and selling software according to claim 4, further comprising a step of practicing a second sale of the software to which said version-upgrade has been carried out.

7. A method of maintaining and selling software according to claim 6, wherein in said first and second sales, a license for executing the programs stored in a server is sold by using a network.

8. A method of maintaining and selling software according to claim 6, wherein in said first and second sales, said software is distributed by using a network.

9. A method of maintaining and selling software according to claim 8, wherein in said second sale, patches associated with said software are distributed by using a network.

10. A method of maintaining and selling software according to claim 9, wherein said network is the Internet.
